(19) United States
(12) Patent Application Publication
(10) Pub. No.: US 2025/0311057 A1
(43) Pub. Date: Oct. 2, 2025

(54) COVER BODY INCLUDING HEAT-GENERATING ELEMENT AND THERMOCOUPLE

(71) Applicant: NICHIAS Corporation, Tokyo (JP)

(72) Inventors: Akira SASAKI, Tokyo (JP); Daisaku SEKI, Tokyo (JP); Kenji IIDA, Tokyo (JP)

(21) Appl. No.: 18/864,971

(22) PCT Filed: May 15, 2023
(86) PCT No.: PCT/JP2023/018153

§ 371 Date: Nov. 12, 2024

(30) Foreign Application Priority Data
May 13, 2022 (JP) 2022-079432

(51) Int. Cl. H05B 3/34

(52) U.S. Cl. CPC H05B 3/34

(57) ABSTRACT

The present invention is a cover body configured to cover an object, including: an inner layer part disposed on a side closer to the object; an outer layer part disposed on a side further from the object; an inner-layer-side heat insulating member disposed on an outer layer part side of the inner layer part; an outer-layer-side heat insulating member disposed on an inner layer part side of the outer layer part; a heat generating element disposed between the inner-layer-side heat insulating member and the outer-layer-side heat insulating member; a sheet configured to provide a stepped part on a side further closer to the object of the inner layer part; and a thermocouple provided on a side further closer to the object of the stepped part.

### TECHNICAL FIELD

The present invention relates to a cover body including a heat generating element and a thermocouple. In particular, the present invention relates to a cover body capable of heating a pipe or the like, such as for a gas supply or a gas exhaust, to a desired temperature and of maintaining the pipe or the like at the desired temperature.

### BACKGROUND ART

Japanese Patent No. 6616265 (Patent Document 1) has disclosed the following structure, as a cover body capable of heating a pipe for a gas supply or a gas exhaust to a desired temperature and of maintaining the pipe at the desired temperature.

As shown in FIG. 21 (which corresponds to FIG. 4(c) of Japanese Patent No. 6616265 (Patent Document 1)), in the cover body of Japanese Patent No. 6616265 (Patent Document 1), between an inner layer part 510 and an outer layer part 500 (which are fluororesin members), a heat generating body 530 such as a heating wire, a heat insulating member 540 (glass cloth material) supporting the heat generating body 530 on an inner layer side thereof, and a heat insulating part 520 (glass fiber) disposed on an outer layer side of the heat generating body 530 are laminated.

Furthermore, in the example shown in FIG. 21, a metal thin plate 400 is interposed between the heat insulating member 540 and the inner layer part 510 and a heat insulating member 600 (alumina cloth material) having a large heat storage degree is provided on a further inner side (on a side of a gas pipe 110) of the inner layer part 510. The metal thin plate 400 and the heat insulating member 600 are arranged to make a heating degree of the gas pipe uniform.

In addition, in order to use an actual temperature of the gas pipe 110 for a feedback control of the heat generating element 530, a temperature detecting portion 555 such as a plate-shaped heat collecting plate is provided so as to be in contact with the gas pipe 110. The temperature detecting portion 555 is further attached to a further inner side (a side of the gas pipe 110) of the heat insulating member 600. A thermocouple, which is not shown in FIG. 21, is connected to the temperature detecting portion 555. In the example shown in FIG. 21, a thermoswitch 560 as a temperature switch (a control unit) is also attached to the further inner side (the side of the gas pipe 110) of the heat insulating member 600.

According to the cover body described above, since a heat of the gas pipe 110 is easily transmitted directly to the temperature detecting portion 555 such as the plate-shaped heat collecting plate, the thermocouple connected to the temperature detecting portion 555 is capable of detecting a temperature of the gas pipe 110 indirectly. Therefore, information of a detected temperature by the thermocouple can be used for a feedback control of the heat generating element 530.

### PRIOR ART DOCUMENT

### Patent Document

Patent Document 1 is Japanese Patent No. 6616265.

### SUMMARY OF INVENTION

### Technical Problem

The inventors have found that when a temperature of a pipe is measured by a thermocouple, it is possible to measure the temperature with a higher accuracy if the thermocouple is applied directly (in addition to a direct contact, a film, patch, or the like, which has only a small effect on a temperature measurement, may be interposed therebetween, at least at the time of filing the present application) to a surface of the pipe (if a body of the pipe is coated with a resin or the like, a surface of the resin or the like is the surface of the pipe) without using a plate-like heat collecting plate (which refers to a plate or foil made of metal having a high thermal conductivity (such as stainless steel or aluminum, or other metal with a thermal conductivity equal to or greater than that of the thermocouple) attached to the thermocouple as a supplement to the thermocouple to allow it to more effectively detect ambient heat) or the like as described above.

However, the inventors have also found that when a thermocouple is simply exposed to the inner side of the heat insulating member 600, a contact state between the thermocouple and the surface of the pipe is not stabilized and it is not possible to measure the temperature with a higher accuracy.

Further, as described above, the heat insulating member 600 is provided to uniformly coat the entire pipe in order to improve temperature uniformity. The inventors have found that even if this function is locally sacrificed, there is no significant influence on the temperature uniformity of the entire pipe.

The present invention has been made based on the above findings. The object of the present invention is to provide a cover body including a heat generating element and a thermocouple wherein the cover body is capable of achieving a highly accurate temperature measurement by stably bringing a thermocouple into a direct contact with a surface of an object.

### Solution to Problem

The present invention is a cover body configured to cover an object, including: an inner layer part disposed on a side closer to the object; an outer layer part disposed on a side further from the object; an inner-layer-side heat insulating member disposed on an outer layer part side of the inner layer part; an outer-layer-side heat insulating member disposed on an inner layer part side of the outer layer part; a heat generating element disposed between the inner-layer-side heat insulating member and the outer-layer-side heat insulating member; a sheet configured to provide a stepped part on a side further closer to the object of the inner layer part; and a thermocouple provided on a side further closer to the object of the stepped part.

According to the present invention, since the stepped part (a portion that is locally raised inwardly relative to a peripheral region thereof) is provided, the stepped part assists in applying the thermocouple stably and directly to a surface of the object. As a result, a more accurate temperature measurement can be achieved.

At least at the time of filing the present application, not excluded is a variation wherein the thermocouple is not exposed, i.e., a thin film or patch or the like (which is made of, for example, a fluororesin, a polyimide resin or an aramid resin and whose upper limit of thickness is about 0.5 mm) is provided on an object side of the thermocouple and the film or patch or the like is interposed between the thermocouple and the object. However, it is preferable that at least a portion of the thermocouple is exposed on the side further closer to the object of the stepped part since a direct contact between the thermocouple and the object is assisted.

In one aspect of the present invention, the sheet is locally provided on the side further closer to the object of the inner layer part as a sheet patch, to provide the stepped part.

According to the above aspect of the present invention, the locally provided sheet patch assists in applying the thermocouple stably and directly to a surface of the object. As a result, a more accurate temperature measurement can be achieved.

According to various experiments by the inventors, it is preferable that the sheet patch is made of an elastic material that can softly press the thermocouple against a surface of the object. Specifically, it is preferable that the sheet patch is made of a fluororesin, a polyimide resin, or an aramid resin. It has been confirmed that even when such a sheet patch is locally provided, there is no significant influence on the temperature uniformity of the entire object. Furthermore, such a sheet patch has the advantage that a direct influence from the heat generating element can be effectively eliminated in the temperature measurement by the thermocouple, because the sheet patch has a heat insulating property and a small heat storage capacity.

When the thermocouple is exposed on or above the sheet patch, it is preferable that an area of the sheet patch (projected area from the inside) is 5 to 400 times an exposed area of the thermocouple (projected area from the inside). Within this range, the thermocouple can be brought into a stable direct contact with a surface of the object without significant influence on the temperature uniformity of the entire object.

Specifically, when the area of the sheet patch is 10 cm×10 cm, if the exposed area of the thermocouple is 1/400 to 1/87 times, it has been confirmed that the effect of the present invention can be obtained (the area of the sheet patch is 87 to 400 times the exposed area of the thermocouple on or above the sheet patch). Furthermore, when the area of the sheet patch is 3 cm×2 cm, if the exposed area of the thermocouple is 1/24 to ⅕ times, it has been confirmed that the effect of the present invention can be obtained (the area of the sheet patch is 5 to 24 times the exposed area of the thermocouple on or above the sheet patch).

For example, the sheet patch has a thickness of 0.1 mm to 5.0 mm. In addition, for example, the sheet patch has a rectangular shape with one side being equal to or less than half an outer circumference of the pipe, or with one side being equal to or less than 10 cm. Alternatively, for example, the sheet patch has a circular or annular shape with a diameter being equal to or less than half an outer circumference of the pipe, or with a diameter being equal to or less than 10 cm.

Note that the technical idea of locally providing a sheet patch can be substituted by locally protruding a sheet patch portion that is a portion of a sheet that extends over the entire object. That is to say, in another aspect of the present invention, a portion of the sheet is locally protruded on the side further closer to the object as a sheet patch portion, to provide the stepped part.

According to the above aspect of the present invention, the locally provided sheet patch portion assists in applying the thermocouple stably and directly to a surface of the object. As a result, a more accurate temperature measurement can be achieved.

According to various experiments by the inventors, it is preferable that (a sheet including) the sheet patch portion is made of an elastic material that can softly press the thermocouple against a surface of the object. Specifically, it is preferable that the sheet including the sheet patch portion is made of a fluororesin, a polyimide resin, or an aramid resin. It has been confirmed that even when (a sheet including) such a sheet patch portion is provided, there is no significant influence on the temperature uniformity of the entire object. Furthermore, such a sheet patch portion has the advantage that a direct influence from the heat generating element can be effectively eliminated in the temperature measurement by the thermocouple, because the sheet patch portion has a heat insulating property and a small heat storage capacity.

When the thermocouple is exposed on or above the sheet patch portion, it is preferable that an area of the sheet patch portion (projected area from the inside) is 5 to 400 times an exposed area of the thermocouple (projected area from the inside).

Within this range, the thermocouple can be brought into a stable direct contact with a surface of the object without significant influence on the temperature uniformity of the entire object.

Specifically, when the area of the sheet patch portion is 10 cm×10 cm, if the exposed area of the thermocouple is 1/400 to 1/87 times, it has been confirmed that the effect of the present invention can be obtained (the area of the sheet patch portion is 87 to 400 times the exposed area of the thermocouple on or above the sheet patch portion). Furthermore, when the area of the sheet patch portion is 3 cm×2 cm, if the exposed area of the thermocouple is 1/24 to ⅕ times, it has been confirmed that the effect of the present invention can be obtained (the area of the sheet patch portion is 5 to 24 times the exposed area of the thermocouple on or above the sheet patch portion).

For example, the sheet, excluding the sheet patch portion, has a thickness of 0.1 mm to 5.0 mm. The sheet patch portion has a thickness of 0.1 mm to 5.0 mm on the sheet. In addition, for example, the sheet patch portion has a rectangular shape with one side being equal to or less than half an outer circumference of the pipe, or with one side being equal to or less than 10 cm. Alternatively, for example, the sheet patch portion has a circular or annular shape with a diameter being equal to or less than half an outer circumference of the pipe, or with a diameter being equal to or less than 10 cm.

In addition, in each cover body described above, it is preferable that the heat generating element and the thermocouple are arranged so as not to overlap each other as seen in a thickness direction from the inner layer part to the outer layer part.

In this case, in a temperature measurement by the thermocouple, a direct influence from the heat generating element can be more effectively eliminated.

In addition, the present invention is a heat generating structure including: an object, which is a straight pipe, an elbow pipe, a flexible pipe, or a valve box; and a cover body having any of the above features.

### Advantageous Effects of Invention

According to the present invention, since the stepped part is provided, the stepped part assists in applying the thermocouple stably and directly to a surface of the object. As a result, a more accurate temperature measurement can be achieved.

In particular, according to one aspect of the present invention, according to the above aspect of the present invention, the locally provided sheet patch assists in applying the thermocouple stably and directly to a surface of the object. As a result, a more accurate temperature measurement can be achieved.

Alternatively, according to another aspect of the present invention, the sheet patch portion locally protruded on the sheet assists in applying the thermocouple stably and directly to a surface of the object. As a result, a more accurate temperature measurement can be achieved.

### BRIEF DESCRIPTION OF DRAWINGS

FIG. 1 is a schematic perspective view of a cover body according to an embodiment of the present invention,

FIG. 2 is a schematic cross-sectional view of the cover body shown in FIG. 1;

FIG. 3 is a photograph of another type of thermocouple;

FIG. 4 is a photograph of yet another type of thermocouple;

FIG. 5 is a photograph of yet another type of thermocouple;

FIG. 6 is a perspective view showing a specific example of valve box;

FIG. 7 is a front view showing the specific example of valve box;

FIG. 8 is a schematic longitudinal cross-sectional view showing an example of sheet patch of a non-constant thickness type;

FIG. 9 is a schematic longitudinal cross-sectional view showing another example of sheet patch of a non-constant thickness type;

FIG. 10 is a schematic longitudinal cross-sectional view showing yet another example of sheet patch of a non-constant thickness type;

FIG. 11 is a schematic longitudinal cross-sectional view showing yet another example of sheet patch of a non-constant thickness type;

FIG. 12 is a schematic longitudinal cross-sectional view showing yet another example of sheet patch of a non-constant thickness type;

FIG. 13 is a schematic longitudinal cross-sectional view showing yet another example of sheet patch of a non-constant thickness type;

FIG. 14 is a schematic perspective view of a cover body according to another embodiment of the present invention,

FIG. 15 is a schematic cross-sectional view of the cover body shown in FIG. 14;

FIG. 16 is a schematic cross-sectional view corresponding to FIG. 15 showing another example of sheet patch portion;

FIG. 17 is a schematic cross-sectional view corresponding to FIG. 15 showing yet another example of sheet patch portion;

FIG. 18 is a schematic cross-sectional view corresponding to FIG. 15 showing yet another example of sheet patch portion;

FIG. 19 is a schematic cross-sectional view corresponding to FIG. 15 showing yet another example of sheet patch portion;

FIG. 20 is a schematic cross-sectional view corresponding to FIG. 15 showing yet another example of sheet patch portion; and

FIG. 21 is a schematic cross-sectional view of a conventional cover body.

### DESCRIPTION OF EMBODIMENTS

An embodiment of the present invention will be described below with reference to the attached drawings.

### Embodiment

A cover body 1 according to an embodiment of the present invention is a cover body capable of heating a straight pipe (an example of an object) for a gas supply or a gas exhaust to a desired temperature and of maintaining the straight pipe at the desired temperature. The shape of the cover body 1 (on an inner layer side thereof) is designed and manufactured in advance according to an external appearance configuration of the straight pipe.

### Structure of Cover Body 1

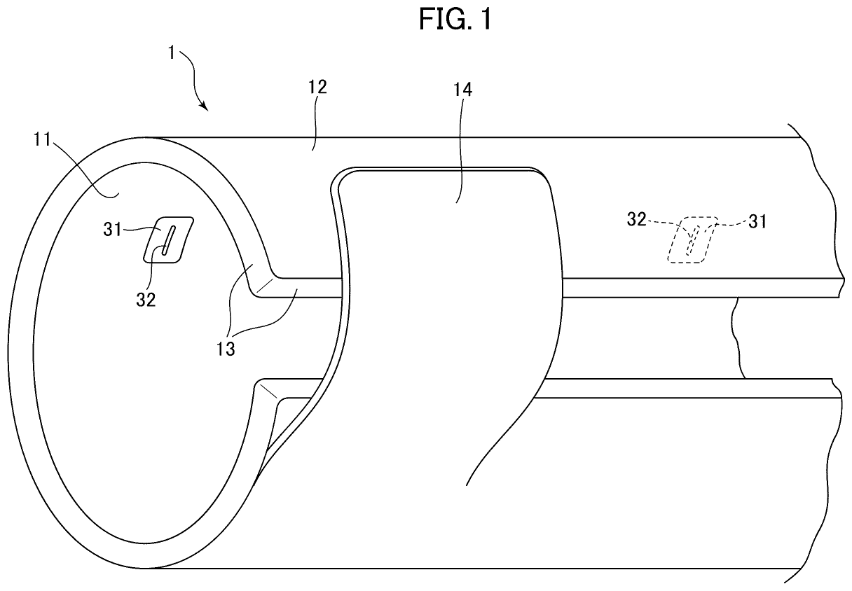

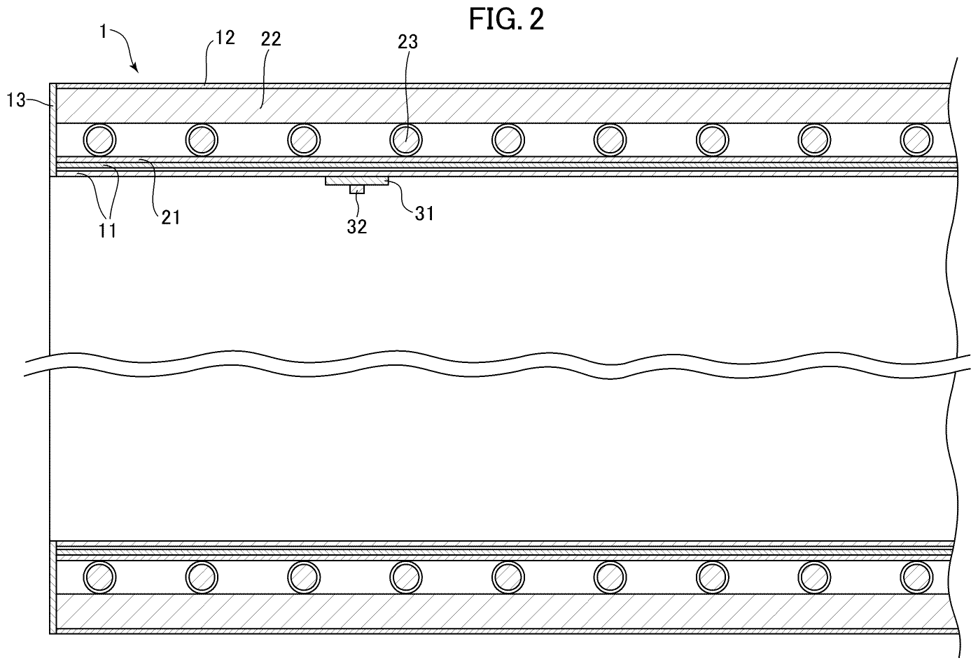

As shown in FIGS. 1 and 2, the cover body 1 of the present embodiment includes: an inner layer part 11 consisting of two laminated glass cloths, fluororesin coating glass cloths, fluororesin porous sheets, or aramid fiber cloth layers; and an outer layer part 12 consisting of a fluororesin coating glass cloth, a silicone resin coating glass cloth, a fluororesin porous sheet, or an aramid fiber cloth layer. The inner layer part 11 is to be disposed on a side closer to the pipe, and the outer layer part 12 is to be disposed on a side further from the pipe.

The cover body 1 has a predetermined thickness (about 20 mm in the present example). The inner layer part 11 and the outer layer part 12 are connected to each other by a side layer part 13 at their side ends. Similarly to the outer layer part 12, the side layer part 13 also consists of a fluororesin coating glass cloth layer.

As shown in FIG. 2, an inner-layer-side heat insulating member 21 is disposed on an outside (outer layer part 12 side) of the inner layer part 11. The inner-layer-side heat insulating member 21 supports a heat generating element 23, which consists of a heating wire, on an inner layer side thereof. An outer-layer-side heat insulating member 22 is disposed on an outside (outer layer part 12 side) of the outer layer part 23.

The inner-layer-side heat insulating member 21 is made of a silica fiber cloth. The heat generating element 23 is made of a nickel-chromium electric heating wire and is sewn to the inner-layer-side heat insulating member 21 by a fluororesin coating glass yarn. The outer-layer-side heat insulating member 22 is made of a glass mat.

In the cover body 1 of the present embodiment, sheet patches 31 are locally provided at two positions on an inner side (pipe side) of the inner layer part 11, as a sheet to provide respective stepped parts (they may be sewn by a yawn or bonded, and they may be provided at one or three or more positions). Each of the sheet patches 31 of the present embodiment is made of a fluororesin, has a moderate elasticity, has a rectangular shape of 3 cm×2 cm (whose area is 6 cm²), and has a thickness of 1.0 mm.

A thermocouple 32 is exposed on a further inner side (pipe side) of each of the sheet patches 31. The thermocouple 32 of the present embodiment is a “sheath straight” type having a diameter of 1 mm, and its entire length thereof, which is 2.0 cm, is exposed. The thermocouple 32 is sewn by a yawn or bonded to the corresponding sheet patch 31.

That is, an exposed area of the thermocouple 32 on the sheet patch 31 (projected area from the inside) is 0.25 cm². As a result, the area of the sheet patch 31 (the projected area from the inside) is 24 times the exposed area of the thermocouple 32 on the sheet patch 31 (projected area from the inside).

A base end side of the thermocouple 32 can be connected to a control unit (for example, a thermostat) (not shown) via a lead wire (not shown) that penetrates the cover body 1 (the corresponding sheet patch 31, the inner layer part 11, the inner-layer-side heat insulating member 21, the outer-layer-side heat insulating member 22 and the outer layer part 12). The control unit can also be connected to the heat generating element 23 via another lead wire that penetrates the outer layer part 12 and the outer-layer-side heat insulating member 22. The control unit controls energization of the heat generating element 23 in response to a temperature measurement value obtained by the thermocouple 32.

In addition, in the cover body 1 of the present embodiment, a fastening part 14 is provided on an outer surface portion of the outer layer part 12. A fastener of the fastening part 14 and a fastener of the outer layer part 12 are fastened by a hook, a belt, a hook-and-loop fastener, a string, or a fluorine rubber ring, so that the cover body 1 is configured to be fixed on a pipe, which is an object.

### Effects of Cover Body 1

As described above, the shape of the cover body 1 (on the inner layer side thereof) is designed and manufactured in advance according to an external appearance configuration of a pipe which is an object. Then, the cover body 1 is fixed on the pipe by fastening the fastener of the fastening part 14 and the fastener of the outer layer part 12.

In this fixation, in the cover body 1 of the present embodiment, although the thermocouple 32 is exposed on the pipe side, since the sheet patch 31 has elasticity enough to softly press the thermocouple 32 against a surface of the pipe, the thermocouple 32 can be stably brought into a direct contact with the surface of the pipe.

Herein, since the sheet patch 31 is only locally provided correspondingly to the installation position of the thermocouple 32, it has been confirmed that there is no significant adverse influence on the temperature uniformity of the entire pipe.

According to the cover body 1 of the present embodiment as described above, it is assisted by the locally provided sheet patch 31 to stably bring the thermocouple 32 into a direct contact with the surface of the pipe. As a result, a more accurate temperature measurement can be achieved.

Then, the thermocouple 32 is connected to a control unit (such as a thermostat) (not shown), and the control unit controls the energization of the heat generating element 23 in response to the temperature measurement value obtained by the thermocouple 32. As a result, the control of the energization of the heat generating element 23 can be performed with higher accuracy.

Herein, according to the cover body 1 of the present embodiment, the sheet patch 31 has a heat insulating property and a small heat storage capacity. Thus, advantageously, a direct influence from the heat generating element 23 can be effectively eliminated in the temperature measurement by the thermocouple 32. In addition, when the heat generating element 23 and the exposed portion of the thermocouple 32 are arranged so as not to overlap each other as seen in a thickness direction from the inner layer part 11 to the outer layer part 12, the direct influence from the heat generating element 23 can be more effectively eliminated.

### Variation of Sheet Patch

In the above embodiment, the sheet patch 31 has a rectangular shape of 3 cm×2 cm, and the area of the sheet patch 31 is 24 times the exposed area of the thermocouple 32 on the sheet patch 31. However, the present invention is not limited thereto. According to the inventors, when the sheet patch 31 has an area of 3 cm×2 cm, if the exposed area of the thermocouple is 1/24 to ⅕ times, it has been confirmed that the effect of the present invention can be obtained (the area of the sheet patch being 5 to 24 times the exposed area of the thermocouple on the sheet patch).

In addition, according to the inventors, when the sheet patch 31 has a rectangular shape of 10 cm×10 cm, if the exposed area of the thermocouple is 1/400 to 1/87 times, it has been confirmed that the effect of the present invention can be obtained (the area of the sheet patch being 87 to 400 times the exposed area of the thermocouple on the sheet patch).

Furthermore, the sheet patch 31 may have a rectangular shape of other sizes. For example, when the sheet patch 31 has a rectangular shape with one side being equal to or less than 10 cm, it has been confirmed that the effect of the present invention can be obtained. With respect to a relationship with an outer circumference of the pipe, when the sheet patch 31 has a rectangular shape with one side being equal to or less than half of the outer circumference of the pipe (preferably, equal to or less than one fourth of the outer circumference of the pipe), it has been confirmed that the effect of the present invention can be obtained (such a sheet patch 31 can softly press the thermocouple 32 against a surface of the pipe, so that the thermocouple 32 can be stably brought into a direct contact with the surface of the pipe).

Alternatively, the sheet patch 31 can have various shapes without being limited to a rectangular shape. For example, the sheet patch 31 may have a circular shape, an elliptical shape, or an annular shape. In the case of the annular shape, the region of a center hole may overlap the thermocouple 32. When the sheet patch 31 has a circular shape, an elliptical shape, or an annular shape, if a diameter thereof, twice of the major axis radius (a length of the major axis) thereof, or an outer diameter thereof is 10 cm or less, the effects of the present invention can be expected. With respect to a relationship with an outer circumference of the pipe, when the sheet patch 31 has a diameter, twice the major axis radius, or an outer diameter which is equal to or less than half of the outer circumference of the pipe (preferably, equal to or less than one fourth of the outer circumference of the pipe), it has been confirmed that the effect of the present invention can be obtained (such a sheet patch 31 can softly press the thermocouple 32 against a surface of the pipe, so that the thermocouple 32 can be stably brought into a direct contact with the surface of the pipe).

In addition, with respect to a thickness of the sheet patch 31, when the thickness is 0.1 mm to 5.0 mm, the effects of the present invention can be expected. (When the thickness of the sheet patch 31 exceeds 5.0 mm, the distance between the heat generating element 32 and the surface of the pipe at this location becomes excessive, and further, an edge portion of the sheet patch 31 forms an excessive step to leave a gap between the cover body 1 and the surface of the pipe, which may hinder efficient and uniform heating of the pipe.)

### Variation of Thermocouple

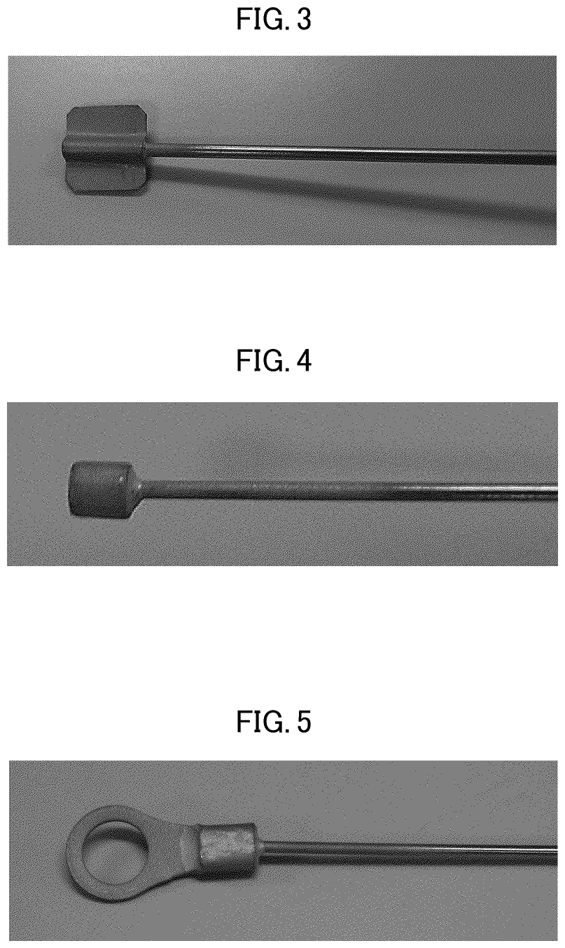

In addition, the present invention is not limited to the “sheath straight” type of thermocouple 32 and may utilize other various types of thermocouples. For example, FIG. 3 is a photograph of a “tip plate attached” type of thermocouple, FIG. 4 is a photograph of a “tip block attached” type of thermocouple, and FIG. 5 is a “tip O-shaped terminal attached” type of thermocouple. The present invention can optionally apply these types of thermocouples (in particular, even a type of thermocouple that is not considered to have a planar shape that can be easily placed along an object).

### Variation of Entire Shape

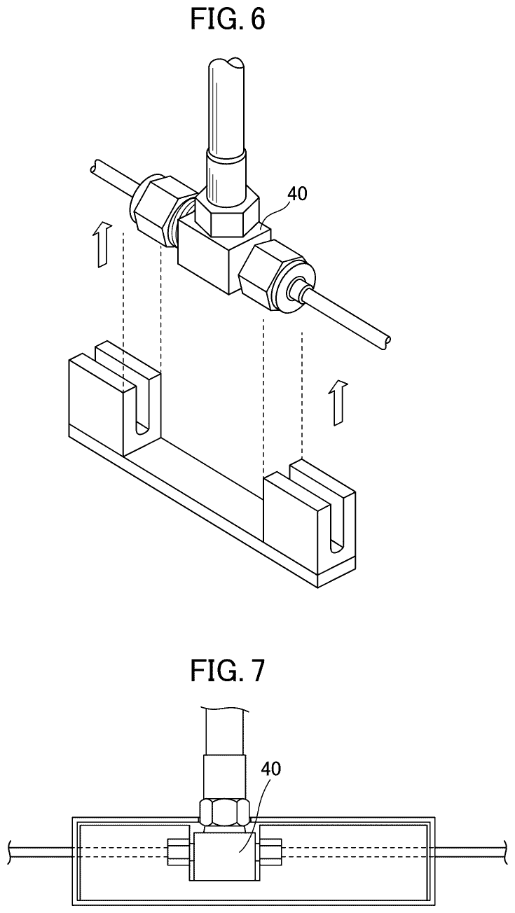

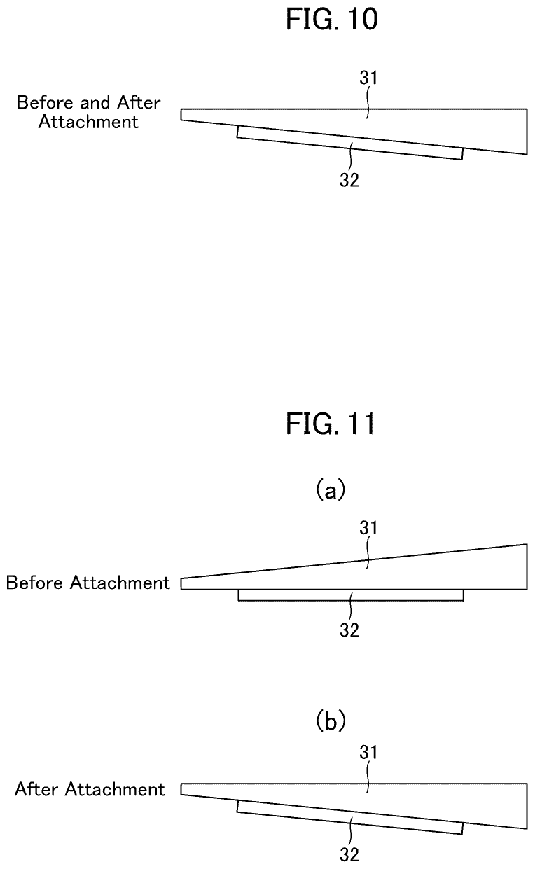

In the above embodiment, the entire shape (form) of the cover body 1 is designed and manufactured with respect to the straight-shaped pipe. However, the present invention is not limited thereto. The entire shape of the cover body 1 may be designed and manufactured for any pipe having a straight portion and a curved (bent) portion. Furthermore, the entire shape of the cover body 1 may be designed and manufactured with respect to an object having a complicated shape, such as a valve box (a box for accommodating a valve unit). FIGS. 6 and 7 illustrate a specific structural example of the valve box 40 (FIGS. 6 and 7 are based on FIGS. 10 and 11 of the preceding patent (JP Patent No. 6596025) by the present applicant).

The present invention also includes an entire heat generating structure including: the object (for example, a straight pipe, an elbow pipe, a flexible pipe, or a valve box) and the cover body 1 that covers the object.

### Thickness of Sheet Patch

The thickness of the sheet patch 31 increases the effect of pressing the thermocouple 32 when it is thick, whereas when the sheet patch 31 is too thick, the heating of the sheet patch 31 becomes insufficient to cause temperature unevenness. Therefore, it is desirable that the thickness of the sheet patch 31 is appropriately selected according to respective types and dimensions of the object and the cover body 1, as well as a type and dimension of the thermocouple 32, and the like.

In addition, in the above embodiment and the above respective variations, the thickness of the sheet patch 31 is presupposed to be constant or substantially constant in the entirety of the sheet patch 31. However, the present invention is not limited thereto.

For example, by making a region of the sheet patch 31 located on a distal end side of the thermocouple 32 thicker than a region of the sheet patch 31 located on a root side of the thermocouple 32, the effect of pressing the tip side of the thermocouple 32 against the object can be made more reliable. When the distance between the thermocouple 32 and the object is reduced by this effect, the influence of thermal noise directly reaching the thermocouple 32 from the heat generating element 23 (which consists of a heating wire) is suppressed.

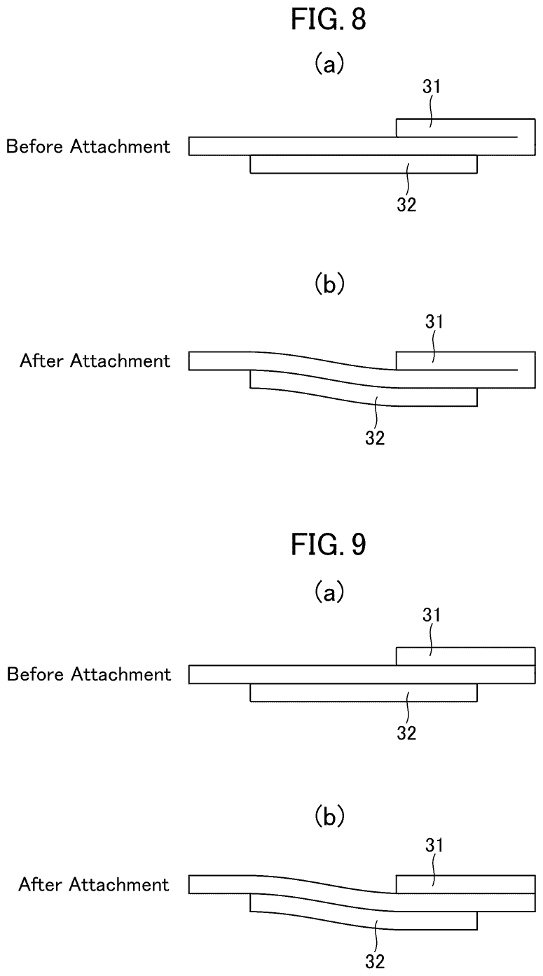

As a specific aspect of making the region of the sheet patch 31 located on the distal end side of the thermocouple 32 thicker than the region of the sheet patch 31 located on the root side of the thermocouple 32, various aspects are considered (possible). FIGS. 8 to 13 are schematic longitudinal cross-sectional views illustrating respective examples of sheet patch 31 of a type in which the thickness is not constant.

FIG. 8 is a schematic longitudinal cross-sectional view illustrating an example of a type of sheet patch 31 in which a region of the sheet patch 31 located on a distal end side (right side in FIG. 8) of the thermocouple 32 has been bent. FIG. 8(a) illustrates a state before an attachment (installation) to the cover body 1, and FIG. 8(b) illustrates a state after the attachment to the cover body 1. In FIG. 8(b), an upper surface side of the sheet patch 31 is bonded or the like to the cover body 1, but the cover body 1 is not illustrated. It is preferable that the number of bending times is two or less (not more than three overlapped sheet patch portions) from the viewpoint of ease of manufacturing (because it is not easy to bend the sheet patch 31 three or more times).

As shown in FIG. 8, by bending the region of the sheet patch 31 located on the distal end side of the thermocouple 32 to the side opposite to the thermocouple 32, the risk of the thermocouple 32 causing undesired deformation or breakage due to undesired “snagging” of the thermocouple 32 with the sheet patch 31 is significantly reduced.

FIG. 9 is a schematic longitudinal cross-sectional view illustrating an example of a type of sheet patch 31 in which a region of the sheet patch 31 located on a distal end side (right side in FIG. 9) of the thermocouple 32 has been formed by two overlapped (stacked) sheets (pieces). FIG. 9(a) illustrates a state before an attachment to the cover body 1, and FIG. 9(b) illustrates a state after the attachment to the cover body 1. In FIG. 9(b), an upper surface side of the sheet patch 31 is bonded or the like to the cover body 1, but the cover body 1 is not illustrated. It is preferable that the number of overlapped sheets (pieces) is three or less from the viewpoint of ease of manufacturing (because it is not easy to overlap four or more sheets (pieces)).

As shown in FIG. 9, by forming the region of the sheet patch 31 located on the distal end side of the thermocouple 32 by the two sheets (pieces) overlapped (stacked) on the side opposite to the thermocouple 32, the risk of the thermocouple 32 causing undesired deformation or breakage due to undesired “snagging” of the thermocouple 32 with the sheet patch 31 is significantly reduced.

FIG. 10 is a schematic longitudinal cross-sectional view illustrating an example of a type of sheet patch 31 in which a region of the sheet patch 31 located on a distal end side (right side in FIG. 10) of the thermocouple 32 is thicker than a region of the sheet patch 31 located on a root side (left side in FIG. 10) of the thermocouple 32 and in which the entire cross-sectional shape of the sheet patch 31 is a “wedge” shape. The thermocouple 32 is provided on an inclined surface side of the wedge-shaped sheet patch 31.

As shown in FIG. 10, by forming the entire cross-sectional shape of the sheet patch 31 into the “wedge” shape, the risk of the thermocouple 32 causing undesired deformation or breakage due to undesired “snagging” of the thermocouple 32 with the sheet patch 31 is significantly reduced.

FIG. 11 is also a schematic longitudinal cross-sectional view illustrating an example of a type of sheet patch 31 in which a region of the sheet patch 31 located on a distal end side (right side in FIG. 11) of the thermocouple 32 is thicker than a region of the sheet patch 31 located on a root side (left side in FIG. 11) of the thermocouple 32 and in which the entire cross-sectional shape of the sheet patch 31 is a “wedge” shape. FIG. 11(a) illustrates a state before an attachment to the cover body 1. The thermocouple 32 is provided on a horizontal surface side of the wedge-shaped sheet patch 31. FIG. 11(b) illustrates a state after the attachment to the cover body 1. In FIG. 11(b), an upper surface side of the sheet patch 31 is bonded or the like to the cover body 1, but the cover body 1 is not illustrated.

According to the example shown in FIG. 11 as well, the risk of the thermocouple 32 causing undesired deformation or breakage due to undesired “snagging” of the thermocouple 32 with the sheet patch 31 is significantly reduced.

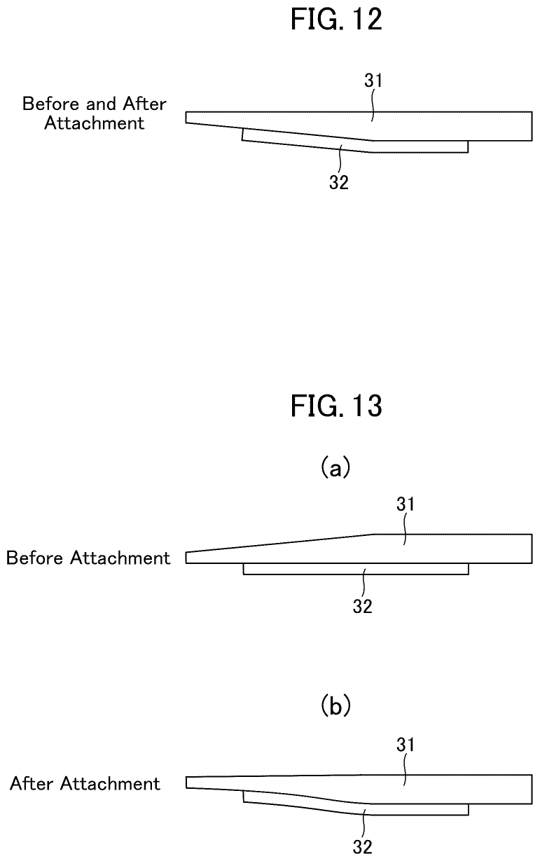

FIG. 12 is a schematic longitudinal cross-sectional view illustrating an example of a type of sheet patch 31 in which a region of the sheet patch 31 located on a distal end side (right side in FIG. 12) of the thermocouple 32 is thicker than a region of the sheet patch 31 located on a root side (left side in FIG. 12) of the thermocouple 32 and in which the cross-sectional shape of a portion of the sheet patch 31 is a “wedge” shape. The thermocouple 32 is provided on an inclined surface side of the sheet patch 31.

As shown in FIG. 12, by forming the cross-sectional shape of a portion of the sheet patch 31 into the “wedge” shape, the risk of the thermocouple 32 causing undesired deformation or breakage due to undesired “snagging” of the thermocouple 32 with the sheet patch 31 is significantly reduced.

FIG. 13 is also a schematic longitudinal cross-sectional view illustrating an example of a type of sheet patch 31 in which a region of the sheet patch 31 located on a distal end side (right side in FIG. 13) of the thermocouple 32 is thicker than a region of the sheet patch 31 located on a root side (left side in FIG. 13) of the thermocouple 32 and in which the cross-sectional shape of a portion of the sheet patch 31 is a “wedge” shape. FIG. 13(a) illustrates a state before an attachment to the cover body 1. The thermocouple 32 is provided on a horizontal surface side of the sheet patch 31. FIG. 13(b) illustrates a state after the attachment to the cover body 1. In FIG. 13(b), an upper surface side of the sheet patch 31 is bonded or the like to the cover body 1, but the cover body 1 is not illustrated.

According to the example shown in FIG. 13 as well, the risk of the thermocouple 32 causing undesired deformation or breakage due to undesired “snagging” of the thermocouple 32 with the sheet patch 31 is significantly reduced.

### Other Embodiments

Although the sheet patch 31 is provided directly on the inner side (pipe side) of the inner layer part 11 in the above embodiment, some intermediate layer may be interposed therebetween, which is also within the scope of the present invention.

Furthermore, the intermediate layer and the sheet patch 31 may be integrally coupled (they may be sewn by a yawn, bonded, or the like), which is also within the scope of the present invention.

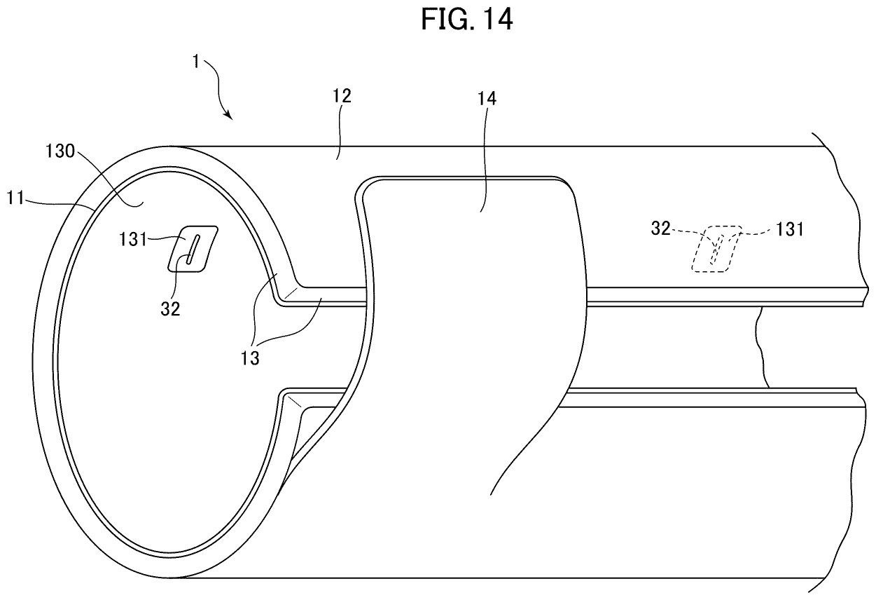

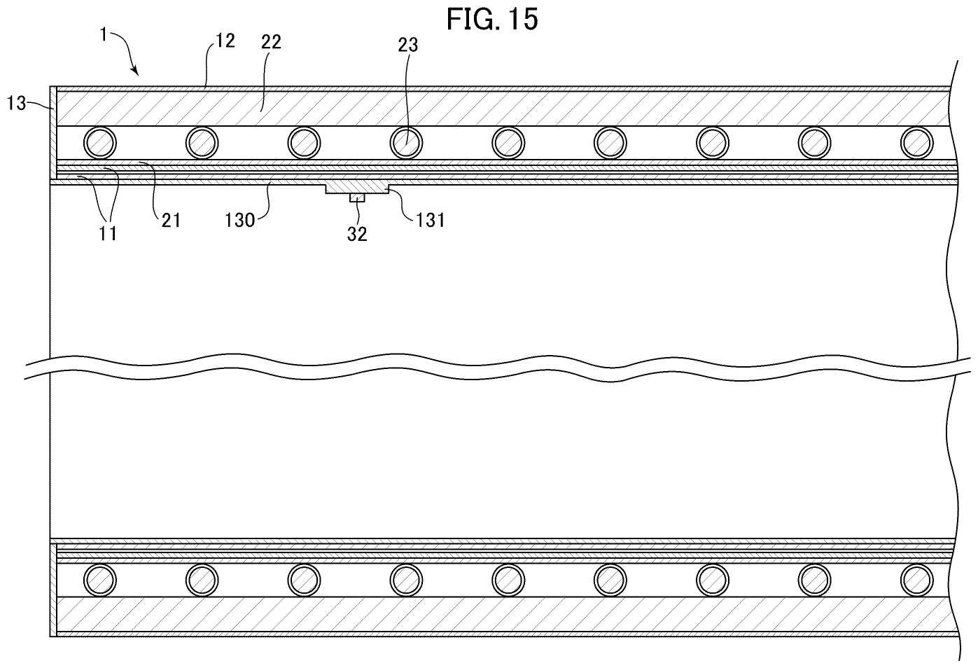

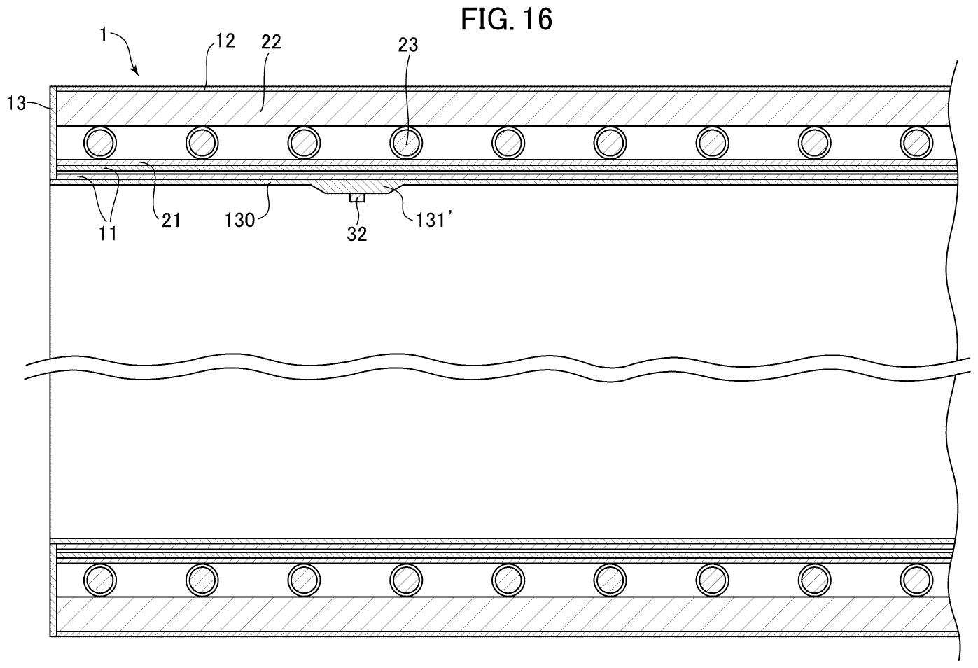

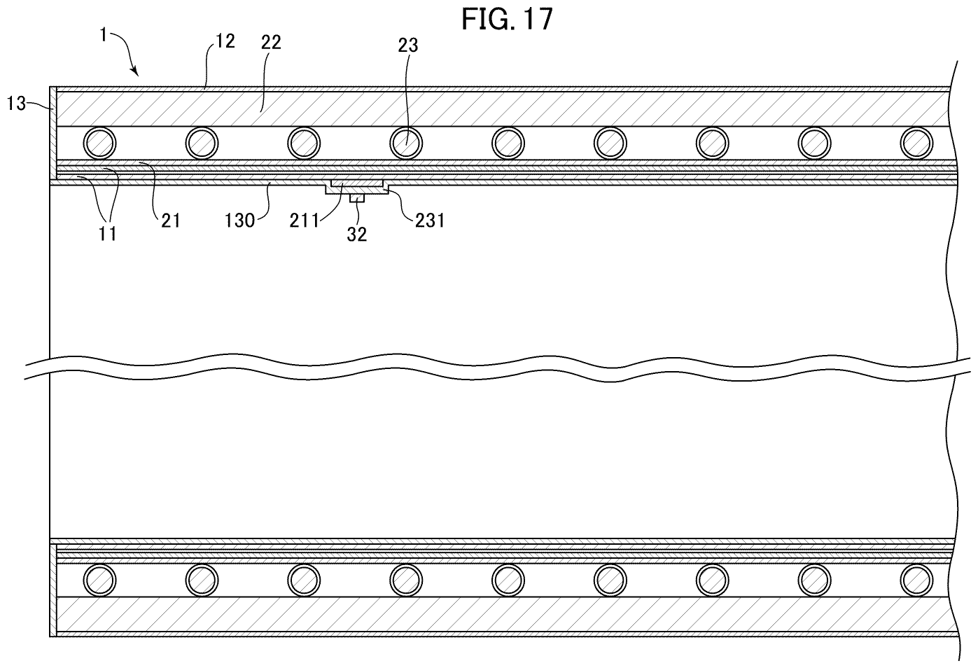

Furthermore, as a sheet for providing the stepped part, instead of the locally disposed sheet patch 31, a sheet 130 including a locally protruded sheet patch portion 131 may be disposed on the inner side (pipe side) of the inner layer part 11. Such an embodiment is shown in FIGS. 14 and 15. In the embodiment shown in FIGS. 14 and 15, a sheet 130 is disposed on an inner side (pipe side) of the inner layer part 11, the sheet 130 including two sheet patch portions 131 which are locally protruded at respective two positions (one or three or more sheet patch portions 131 may be protruded at one or three or more positions). Each sheet patch portion 131 is configured as a portion thicker than the other portion of the sheet 130, and thus provides a stepped partn (see FIG. 15). The sheet 130 (including the sheet patch portion 131) of the present embodiment is made of a fluororesin and has a moderate elasticity. The thickness of the sheet 130 excluding the sheet patch portion 131 is 0.5 mm. Each sheet patch portion 131 has a rectangular shape of 3 cm×2 cm (whose area is 6 cm²) and has a thickness of 1.0 mm (which is 0.5 mm thicker than the other portion of the sheet 130).

In the embodiment shown in FIGS. 14 and 15, the same structures as the embodiment shown in FIGS. 1 and 2 are represented by the same reference signs, and detailed description thereof is omitted.

In the embodiment shown in FIGS. 14 and 15 as well, although the thermocouple 32 is exposed on the pipe side, since the sheet patch portion 131 has elasticity enough to softly press the thermocouple 32 against a surface of the pipe, the thermocouple 32 can be stably brought into a direct contact with the surface of the pipe.

Herein, since the sheet patch portion 131 is only locally provided correspondingly to the installation position of the thermocouple 32, it has been confirmed that there is no significant adverse influence on the temperature uniformity of the entire pipe.

According to the embodiment shown in FIGS. 14 and 15 as well, it is assisted by the locally provided sheet patch portion 131 to stably bring the thermocouple 32 into a direct contact with the surface of the pipe. As a result, a more accurate temperature measurement can be achieved.

Then, the thermocouple 32 is connected to the control unit (such as a thermostat) (not shown), and the control unit controls the energization of the heat generating element 23 in response to the temperature measurement value obtained by the thermocouple 32. As a result, the control of the energization of the heat generating element 23 can be performed with higher accuracy.

According to the embodiment shown in FIGS. 14 and 15 as well, since the sheet patch portion 131 has a heat insulating property and a small heat storage capacity, a direct influence from the heat generating element 23 can be effectively eliminated in the temperature measurement by the thermocouple 32. In addition, when the heat generating element 23 and the exposed portion of the thermocouple 32 are arranged so as not to overlap each other as seen in a thickness direction from the inner layer part 11 to the outer layer part 12, the direct influence from the heat generating element 23 can be more effectively eliminated.

### Variation of Sheet Patch Portion

In the embodiment shown in FIGS. 14 and 15, the sheet patch portion 131 has a rectangular shape of 3 cm×2 cm, and the area of the sheet patch portion 131 is 24 times the exposed area of the thermocouple 32 on the sheet patch portion 131. However, the present invention is not limited thereto. According to the inventors, when the sheet patch portion 131 has an area of 3 cm×2 cm, if the exposed area of the thermocouple is 1/24 to ⅕ times, it has been confirmed that the effect of the present invention can be obtained (the area of the sheet patch portion being 5 to 24 times the exposed area of the thermocouple on the sheet patch portion).

In addition, according to the inventors, when the sheet patch portion 131 has a rectangular shape of 10 cm×10 cm, if the exposed area of the thermocouple is 1/400 to 1/87 times, it has been confirmed that the effect of the present invention can be obtained (the area of the sheet patch portion being 87 to 400 times the exposed area of the thermocouple on the sheet patch portion).

Furthermore, the sheet patch portion 131 may have a rectangular shape of other sizes. For example, when the sheet patch portion 131 has a rectangular shape with one side being equal to or less than 10 cm, it has been confirmed that the effect of the present invention can be obtained. With respect to a relationship with an outer circumference of the pipe, when the sheet patch portion 131 has a rectangular shape with one side being equal to or less than half of the outer circumference of the pipe (preferably, equal to or less than one fourth of the outer circumference of the pipe), it has been confirmed that the effect of the present invention can be obtained (such a sheet patch portion 131 can softly press the thermocouple 32 against a surface of the pipe, so that the thermocouple 32 can be stably brought into a direct contact with the surface of the pipe).

Alternatively, the sheet patch portion 131 can have various shapes without being limited to a rectangular shape. For example, the sheet patch portion 131 may have a circular shape, an elliptical shape, or an annular shape. In the case of the annular shape, the region of a center hole may overlap the thermocouple 32. When the sheet patch portion 131 has a circular shape, an elliptical shape, or an annular shape, if a diameter thereof, twice of the major axis radius (a length of the major axis) thereof, or an outer diameter thereof is 10 cm or less, the effects of the present invention can be expected. With respect to a relationship with an outer circumference of the pipe, when the sheet patch portion 131 has a diameter, twice the major axis radius, or an outer diameter which is equal to or less than half of the outer circumference of the pipe (preferably, equal to or less than one fourth of the outer circumference of the pipe), it has been confirmed that the effect of the present invention can be obtained (such a sheet patch portion 131 can softly press the thermocouple 32 against a surface of the pipe, so that the thermocouple 32 can be stably brought into a direct contact with the surface of the pipe).

In addition, with respect to a thickness of the sheet patch portion 131, when the thickness is 0.1 mm to 5.0 mm, the effects of the present invention can be expected. (When the thickness of the sheet patch portion 131 exceeds 5.0 mm, the distance between the heat generating element 32 and the surface of the pipe at this location becomes excessive, and further, an edge portion of the sheet patch portion 131 forms an excessive step to leave a gap between the cover body 1 and the surface of the pipe, which may hinder efficient and uniform heating of the pipe.)

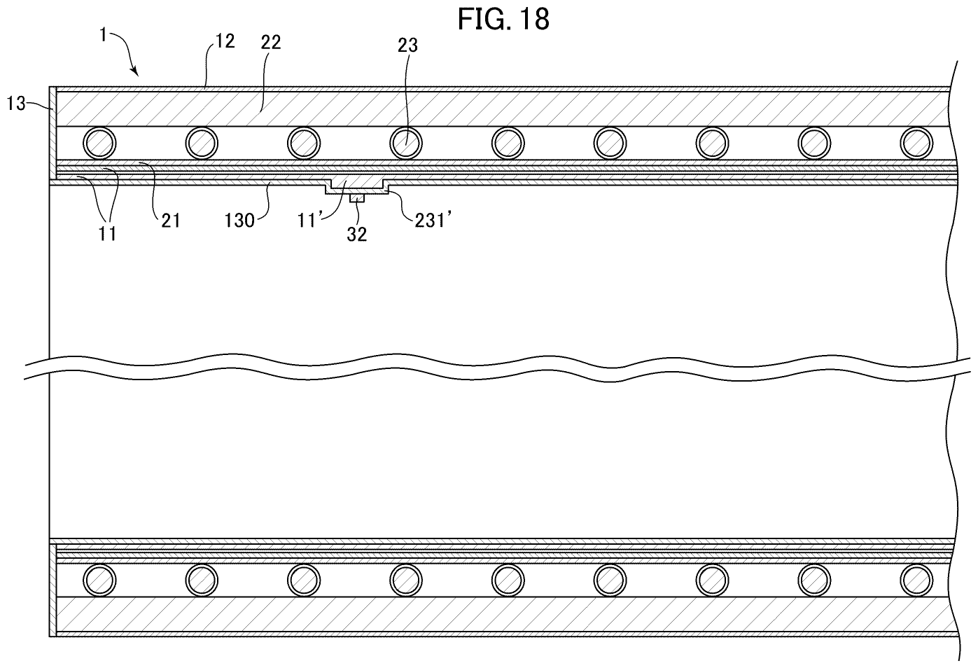

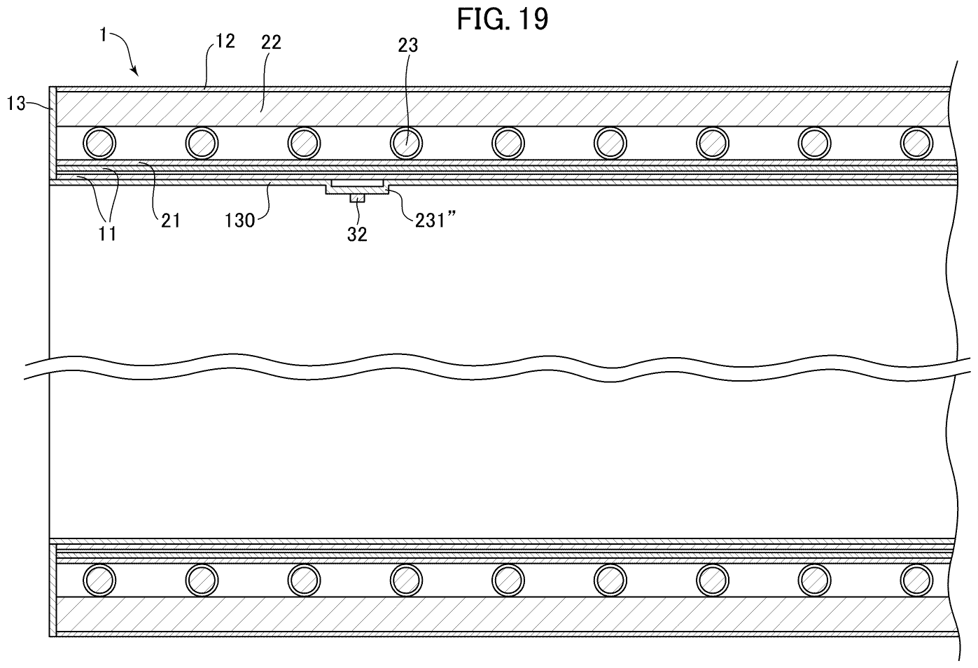

In addition, as a sheet patch portion 131′ shown in FIG. 16, a shape (form) in which a peripheral edge portion is gently inclined may be adopted. In addition, as a sheet patch portion 231 shown in FIG. 17, the stepped part may be provided by interposing a bulky element (stepped-part forming element) 211 on the inner side (pipe side) of the inner layer part 11 and then arranging a sheet 130 thereon, wherein the sheet 130 has a constant or substantially constant thickness in the entire sheet 130.

In addition, as a sheet patch portion 231′ shown in FIG. 18, the stepped part may be provided by raising a bulky portion (stepped-part forming portion) 11′ on the inner side (pipe side) of the inner layer part 11 and then arranging a sheet 130 thereon, wherein the sheet 130 has a constant or substantially constant thickness in the entire sheet 130.

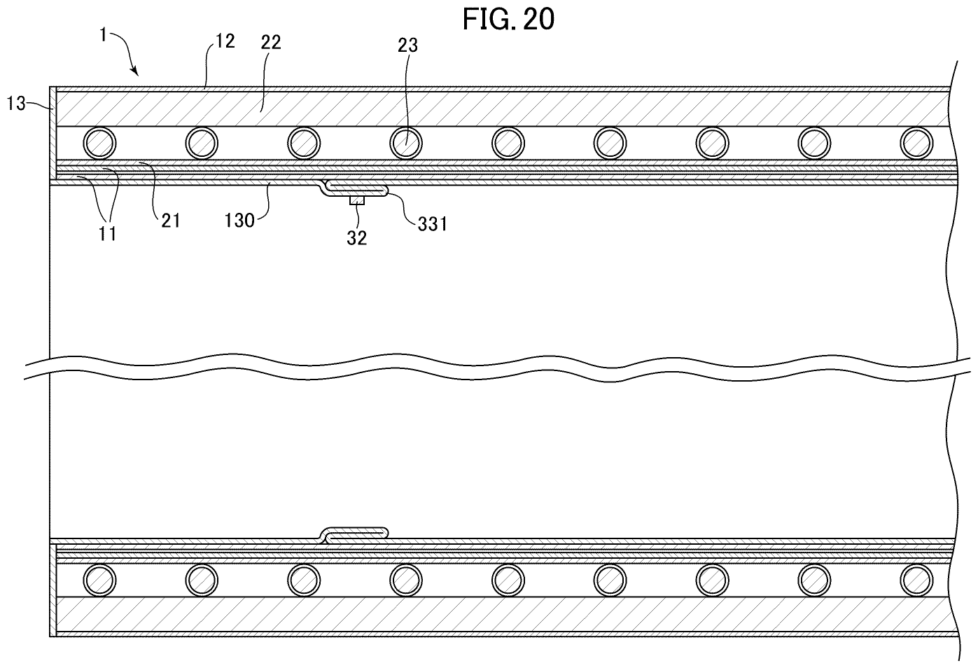

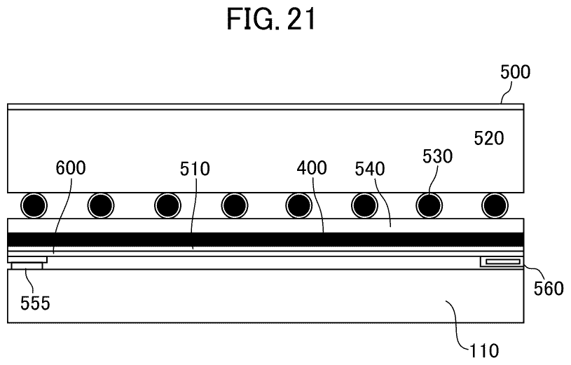

In addition, as a sheet patch portion 231″ shown in FIG. 19, the stepped part may be provided by processing a portion of a sheet 130 into a protruding shape on the inner side (pipe side) by means of some embossing technique or the like.

In addition, as a sheet patch portion 331 shown in FIG. 20, the stepped part may be provided by arranging a portion of a sheet 130 so as to be folded into an S-shaped cross-section.

### EXPLANATION OF SIGN

1 cover body
11 inner layer part
11′ bulky portion (stepped-part forming portion)
12 outer layer part
13 side layer part
14 fastening part
21 inner-layer-side heat insulating member
22 outer-layer-side heat insulating member
23 heat generating element
31 sheet patch
32 thermocouple
40 valve box (box for accommodating a valve unit)
110 gas pipe
130 sheet
131 sheet patch portion
131′ sheet patch portion
211 bulky element (stepped-part forming element)
231 sheet patch portion
231′ sheet patch portion
231″ sheet patch portion
331 sheet patch portion
400 metal thin plate
500 outer layer part
510 inner layer part
520 heat insulating part
530 heating generating element
540 heat insulating member
555 temperature detecting portion
560 thermoswitch
600 heat insulating member

What is claimed is:

1. A cover body configured to cover an object, comprising
an inner layer part disposed on a side closer to the object,
an outer layer part disposed on a side further from the object,
an inner-layer-side heat insulating member disposed on an outer layer part side of the inner layer part,
an outer-layer-side heat insulating member disposed on an inner layer part side of the outer layer part,
a heat generating element disposed between the inner-layer-side heat insulating member and the outer-layer-side heat insulating member,
a sheet configured to provide a stepped part on a side further closer to the object of the inner layer part, and
a thermocouple provided on a side further closer to the object of the stepped part.

2. The cover body according to claim 1, wherein
at least a portion of the thermocouple is exposed on the side further closer to the object of the stepped part.

3. The cover body according to claim 1, wherein
the sheet is locally provided on the side further closer to the object of the inner layer part as a sheet patch, to provide the stepped part.

4. The cover body according to claim 3, wherein
the sheet patch is made of a fluororesin, a polyimide resin, or an aramid resin.

5. The cover body according to claim 3, wherein
at least a portion of the thermocouple is exposed on the side further closer to the object of the stepped part, and
an area of the sheet patch is 5 to 400 times an area of the thermocouple exposed on or above the sheet patch.

6. The cover body according to claim 3, wherein
the sheet patch has a thickness of 0.1 mm to 5.0 mm.

7. The cover body according to claim 3, wherein
the sheet patch has a rectangular shape with one side being equal to or less than half an outer circumference of the pipe.

8. The cover body according to claim 3, wherein
the sheet patch has a circular or annular shape with a diameter being equal to or less than half an outer circumference of the pipe.

9. The cover body according to claim 1, wherein
a portion of the sheet is locally protruded on the side further closer to the object as a sheet patch portion, to provide the stepped part.

10. The cover body according to claim 9, wherein
the sheet is made of a fluororesin, a polyimide resin, or an aramid resin.

11. The cover body according to claim 9, wherein
at least a portion of the thermocouple is exposed on the side further closer to the object of the stepped part, and
an area of the sheet patch portion is 5 to 400 times an area of the thermocouple exposed on or above the sheet patch.

12. The cover body according to claim 9, wherein
the sheet patch portion has a thickness of 0.1 mm to 5.0 mm.

13. The cover body according to claim 9, wherein
the sheet patch portion has a rectangular shape with one side being equal to or less than half an outer circumference of the pipe.

14. The cover body according to claim 9, wherein
the sheet patch portion has a circular or annular shape with a diameter being equal to or less than half an outer circumference of the pipe.

15. The cover body according to claim 1, wherein
the heat generating element and the thermocouple are arranged so as not to overlap each other as seen in a thickness direction from the inner layer part to the outer layer part.

16. A heat generating structure comprising:
an object, which is a straight pipe, an elbow pipe, a flexible pipe, or a valve box, and
the cover body according to claim 1, which covers the object.
